(19) United States
(12) Patent Application Publication
(10) Pub. No.: US 2017/0107354 A1
(43) Pub. Date: Apr. 20, 2017

(54) SEALING COMPOSITION AND METHOD OF PRODUCING THE SAME

(71) Applicant: 3M INNOVATIVE PROPERTIES COMPANY, St. Paul, MN (US)

(72) Inventors: Takujiro Yamabe, Kanagawa (JP); Kyoko Takakuwa, Kanagawa (JP)

(21) Appl. No.: 15/300,663

(22) PCT Filed: Mar. 27, 2015
(86) PCT No.: PCT/US2015/022929

§ 371 Date: Sep. 29, 2016

(30) Foreign Application Priority Data
Apr. 3, 2014 (JP) 2014-076887

(51) Int. Cl. C08K 9/06; C09K 3/10; C08K 5/11; C08K 7/28; C08K 5/12

(52) U.S. Cl. CPC C08K 9/06; C08K 7/28; C08K 5/12; C08K 5/11; C09K 3/10; C09K 2200/0635; C09K 2200/0243

(57) ABSTRACT

Provided are low-density sealing compositions having high tensile strength and a method of producing the same. The sealing compositions may contain a polyvinyl chloride resin, surface-treated hollow glass microspheres and a plasticizer, and contains 30 to 60 vol % hollow glass microsphere.

### TECHNICAL FIELD

The present disclosure relates to a sealing composition and a method of producing the same, and more specifically relates to a sealing composition that can be used for sealing gaps between members constituting automobiles, ships, trains, and other vehicles, as well as a method of producing the same.

### BACKGROUND TECHNOLOGY

Polyvinyl chloride resin is widely used as a base polymer of sealing compositions because it is inexpensive and has excellent physical and chemical properties. Because the density of sealing compositions containing polyvinyl chloride resin is comparatively high (for example, about 1.4 to 1.8 g/cm³), this becomes a factor impeding weight reduction of vehicles, and the like.

The use of hollow fillers as one method for weight reduction of sealing compositions has been studied from the past. However, weight reduction is often associated with lowering of mechanical strength of the cured product of the sealing composition, and as a result the desired mechanical strength may not be obtained in composite materials containing such cured product. For example, a sealing composition having a density of 0.7 to 0.9 g/cm³ or lower, which is about half that of commercially available sealing compositions, and having a tensile strength of the cured product of 0.8 MPa or higher is desired in certain applications.

Patent document 1 (Japanese Unexamined Patent Application Publication No. H3-020384) describes “a body sealer containing particulate and hollow glass beads at a weight ratio of 5% or higher.”

Patent document 2 (Japanese Unexamined Patent Application Publication No. H11-092747) describes “a sealant for vehicle use having low specific gravity and high physical properties and containing a vinyl chloride-based resin, the sealant thereof being obtained by blending with a hollow glass filler that has been surface treated using a silane coupling agent.”

Patent document 3 (Japanese Translation of International Patent Application No. 2012-525485) describes “a composite body containing hollow glass microspheres and a polymer, the composite body containing (a) 30 to 87 vol % of hollow glass microspheres coated with a surface modifier to 0.005 to 8 wt % based on the composite body and having a particle size exceeding about 5 μm, and (b) a polymer phase.”

### SUMMARY

The present disclosure provides a low-density sealing composition having high tensile strength, and a method of producing the same.

According to one embodiment of the present disclosure, there is provided a sealing composition containing a polyvinyl chloride resin, surface-treated hollow glass microspheres, and a plasticizer, the sealing composition containing 3 to 60 vol % of the hollow glass microspheres.

According to another embodiment of the present disclosure, there is provided a method of producing the above sealing composition, the method including surface treating hollow glass microspheres with a silane compound, and mixing the surface-treated hollow glass microspheres with a polyvinyl chloride resin and a plasticizer.

According to the present disclosure, there can be obtained a sealing composition having low density and having high tensile strength due to a large content of hollow glass microspheres. The sealing composition of the present disclosure can be used particularly ideally in applications such as automotive paints.

The above description shall not be construed as disclosing all embodiments of the present invention or all advantages related to the present invention.

### BRIEF DESCRIPTION OF THE DRAWINGS

FIG. 1 is a graph showing the relationship between the amount of silane compound used in the embodiments and tensile strength of the cured product.

FIG. 2A is a SEM photograph (200×) of the tensile fracture surface of the cured product of the sealing composition of Example 13.

FIG. 2B is a SEM photograph (1000×) of the tensile fracture surface of the cured product of the sealing composition of Example 13.

### DETAILED DESCRIPTION

The present invention is described in further detail below in order to illustrate typical embodiments, but the present invention is not limited to these embodiments.

“(Meth)acrylic” in the present disclosure signifies “acrylic” or “methacrylic,” and “(meth)acrylate” signifies “acrylate” or methacrylate.”

The sealing composition in one embodiment of the present disclosure contains a polyvinyl chloride resin, surface-treated hollow glass microspheres, and a plasticizer, and contains 30 to 60 vol % of hollow glass microspheres.

Vinyl chloride homopolymers, vinyl chloride-based copolymers of vinyl chloride monomers with ethylene, vinyl acetate, hydroxyethyl (meth)acrylate, hydroxypropyl (meth)acrylate, (meth)acrylic acid, and the like, or mixtures thereof can be used as polyvinyl chloride resins. These vinyl chloride homopolymers and vinyl chloride-based copolymers can be obtained, for example, by emulsion polymerization, suspension polymerization, microsuspension polymerization, or block polymerization. The amount of vinyl chloride homopolymer contained in the polyvinyl chloride resin can be about 40 mass % or higher, about 50 mass % or higher, or about 60 mass % or higher, to 100 mass % or lower, about 90 mass % or lower, or about 80 mass % or lower, based on the mass of the polyvinyl chloride resin.

The polyvinyl chloride resin can be used conveniently as a solution or dispersion of powder of vinyl chloride homopolymer or vinyl chloride-based copolymer powder dissolved or dispersed in cyclohexane, methyl ethyl ketone, methyl isobutyl ketone, cyclohexanone, tetrahydrofuran, or other organic solvents, or as a sol (paste) of a micropowder of a vinyl chloride homopolymer or vinyl chloride-based copolymer mixed with a plasticizer to be described later. When the polyvinyl chloride resin is used as a sol, the viscosity of the sol may be, for example, about 1000 mPa·s or higher or about 2000 mPa·s or higher, to about 20000 mPa·s or lower or about 5000 mPa·s or lower.

The average degree of polymerization (or average number molecular weight) of the polyvinyl chloride resin is not particularly limited. For example, the k value determined based on JIS K7367-2 (1999 edition ISO 1628-2) with respect to the soluble portion of the polyvinyl chloride resin may be about 50 or higher or about 60 or higher, to about 95 or lower or about 85 or lower. When the polyvinyl chloride resin is a mixture, the k value indicates that which was measured with respect to the mixture.

The polyvinyl chloride resin generally is contained in the sealing composition in an amount of about 5 parts by mass or higher, about 10 parts by mass or higher, or about 15 parts by mass or higher, to about 50 parts by mass or lower, about 40 parts by mass or lower, or about 30 parts by mass or lower based on 100 parts by mass of the sealing composition.

Ingredients of glass are conventionally designated in terms of metal oxides. The hollow glass microspheres mainly contain soda lime borate glass containing silicon dioxide (SiO₂), Na₂O, and other alkali metal oxides, CaO, MgO, SrO, BaO, and other alkali earth metal oxides, boric acid (B₂O₃), other divalent to pentavalent metal oxides (for example, ZnO, PbO; Al₂O₃, Fe₂O₃, Sb₂O₃, TiO₂, MnO₂, ZrO₂; P₂O₅, V₂O₅, and the like), fluorine, sulfur, and the like. The hollow glass microspheres can be produced by known methods in the present technical field, for example, those described in Japanese Unexamined Patent Application Publication No. S58-156551, Japanese Examined Patent Application Publication No. H2-27295, and the like.

The average degree of vacuum of the hollow glass microspheres can be set to about 0.10 g/cm³ or higher, about 0.20 g/cm³ or higher, or about 0.30 g/cm³ or higher, to about 1.0 g/cm³ or lower, about 0.70 g/cm³ or lower, or about 0.50 g/cm³ or lower. Setting the average degree of vacuum to the above range allows the density of the sealing composition to be decreased without excessively damaging the hollow glass microspheres during production and use of the sealing composition. The average degree of vacuum of the hollow glass microspheres can be determined based on ASTM D2840-69 (1976 edition).

The volume median diameter of the hollow glass microspheres can be set to about 5 μm or higher or about 10 μm or higher, to about 100 μm or lower or about 50 μm or lower. Volume median diameter, expressed also as a D50 particle size, signifies the particle size where the cumulative volume from the smallest particle size becomes 50%. In other words, 50 vol % of the hollow glass microspheres are at or below the volume median diameter. Setting the volume median diameter to the above range allows adequate fluidity to be provided to the sealing composition while increasing the filler content of the hollow glass microspheres. The volume median diameter can be determined by dispersing the hollow glass microspheres in degassed and deionized water and measuring by laser diffraction.

The particle size distribution of the hollow glass microspheres may be a Gaussian distribution, normal distribution, or non-normal distribution. A non-normal distribution may have a single peak or multiple peaks (for example, two peaks). The hollow glass microspheres may be graded by sifting to obtain hollow glass microspheres having a desired particle size distribution, or hollow glass microspheres having different particle size distributions may be mixed.

The breaking strength of the hollow glass microspheres generally is about 10 MPa or higher or about 30 MPa or higher, to about 200 MPa or lower or about 180 MPa or lower, when expressed as the pressure at which 10 vol % or 20 vol % of the hollow glass microspheres are broken, that is, as a residual pressure resistance strength at 90 vol % or a residual pressure resistance strength at 80 vol %. The pressure resistance strength of the hollow glass microspheres is desirably high, but in general the average degree of vacuum of hollow glass microspheres having high pressure resistance strength is often high. Accordingly, the pressure resistance strength of the hollow glass microspheres can be suitably selected in accordance with the desired density and strength of the sealing composition. The pressure resistance strength is the value obtained by measurement using glycerol as a dispersing medium based on ASTM D3102-78 (1982 edition). The glycerol dispersion of hollow glass microspheres is set in a test chamber. The change of volume of the hollow glass microspheres in the measurement sample is observed while gradually increasing pressure, the pressure when the residual volume of hollow glass microspheres in the measurement sample becomes 90 vol % or 80 vol % (when 10 vol % break or 20 vol % break) is measured, and this pressure is taken as the 90 vol % residual pressure resistance strength or 80 vol % residual pressure resistance strength.

The hollow glass microspheres are surface treated. It is not the desire to be constrained by any theory, but it is thought that the dispersibility and affinity of the hollow glass microspheres in a matrix composed of the polyvinyl chloride resin and the plasticizer increase due to surface treatment, that boundary separation between the hollow glass microspheres and the matrix is prevented or suppressed, and that as a result, the strength of the cured product of the sealing composition increases. The surface treatment can be performed using a coupling agent containing a silane compound, or the like.

Silane compounds that can be preferably used include compounds having a vinyl group, epoxy group, (meth)acrylic group, amino group, mercapto group, or other functional group and having a silicon-bonded, hydrolyzable halogen atom (chlorine, bromine, or iodine) or alkoxy group. It is advantageous to perform surface treatment using a silane compound containing an aminosilane having an amino group as a function group. It is also advantageous that the hydrolyzable group be an alkoxy group, in particular a C1 to C6 alkoxy group that produces volatile alcohol by hydrolysis, for example, a methoxy group, ethoxy group, propoxy group, or the like.

Examples of useful silane compounds include vinyl trimethoxysilane, vinyl triethoxysilane, and other vinyl silanes; 2-(3,4-epoxycyclohexyl)ethyl trimethoxysilane, 3-glycidoxypropylmethyl dimethoxysilane, 3-glycidoxypropyl trimethoxysilane, 3-glycidoxypropylmethyl diethoxysilane, 3-glycidoxypropyl triethoxysilane, and other epoxysilanes; 3-methacryloxypropylmethyl dimethoxysilane, 3-methacryloxypropyl trimethoxysilane, 3-methacryloxypropylmethyl diethoxysilane, 3-methacryloxypropyl triethoxysilane, 3-acryloxypropyl trimethoxysilane, and other (meth)acrylate silanes; N-2-(aminoethyl)-3-aminopropylmethyl dimethoxysilane, N-2-(aminoethyl)-3-aminopropyl trimethoxysilane, N-2-(aminoethyl)-3-aminopropyl triethoxysilane, 3-aminopropyl trimethoxysilane, 3-aminopropyl triethoxysilane, and other aminosilanes; and 3-mercaptopropylmethyl dimethoxysilane, 3-mercaptopropyl trimethoxysilane, and other mercaptosilanes. Of these silane compounds, it is advantageous to use N-2-(aminoethyl)-3-aminopropylmethyl dimethoxysilane, N-2-(aminoethyl)-3-aminopropyl trimethoxysilane, N-2-(aminoethyl)-3-aminopropyl triethoxysilane, 3-aminopropyl trimethoxysilane, 3-aminopropyl triethoxysilane, and other aminosilanes, and in particular, 3-aminopropyl trimethoxysilane and 3-aminopropyl triethoxysilane can be advantageously used.

Surface treatment of the hollow glass microspheres can be performed by immersing the hollow glass microspheres in a stock solution of a silane compound, an aqueous solution of silane compound, or an alcohol solution, by spraying the hollow glass microspheres with a stock solution of a silane compound, an aqueous solution of a silane compound, or an alcohol solution, or by another known method. Methanol, ethanol, propanol, or the like, can be used as a solvent of an alcohol solution of a silane compound. The hollow glass microspheres may be set aside at room temperature or heated to about 80° C. to about 200° C. after immersing or spraying. The hollow glass microspheres may be preheated to remove water and the like attached to the surface.

The amount of silane compound used can be about 0.1 mass % or higher, about 0.25 mass % or higher, or about 0.4 mass % or higher, to about 5 mass % or lower, about 2 mass % or lower, or about 1 mass % or lower, based on the mass of the hollow glass microspheres. Setting to the above range is economically advantageous as the tensile strength of the cured product can be increased. In a certain preferred embodiment, the amount of silane compound used is about 0.25 mass % or higher to about 1 mass % or lower per the hollow glass microspheres.

The hollow glass microspheres are contained in an amount of about 30 vol % or higher to about 60 vol % or lower in the sealing composition. In a certain embodiment, the hollow glass microspheres are contained in an amount of about 40 vol % or higher or about 45 vol % or higher, to about 60 vol % or lower or about 58 vol % or lower, in the sealing composition. In the sealing composition of the present disclosure, the hollow glass microspheres can be contained at a high filler content in the sealing composition by combining the matrix configured of the polyvinyl chloride resin and the plasticizer with the surface-treated hollow glass microspheres.

Examples of plasticizers that can be used include dibutyl phthalate, dioctyl phthalate (DOP, also referred to as “bis(2-ethylhexyl) phthalate”), diisononyl phthalate (DINP), diisodecyl phthalate, octylbutyl phthalate, and other phthalate esters; diisodecyl succinate, dioctyl adipate (DOA), dibutyl sebacate, dioctyl sebacate, and other nonaromatic dibasic acid esters; trioctyl trimellitate and other trimellitate esters; tributyl acetylcitric acid, butyl maleate, butyl oleate, benzoate esters, methyl acetylricinoleate, and other fatty acid or aromatic acid esters; tributyl phosphate, triphenyl phosphate, tritolyl phosphate (TTP, also referred to as “tricresyl phosphate”), and other phosphate esters; alkyl diphenyls, partially hydrogenated terphenyls, and other hydrocarbon-based oils; chlorinated paraffin; epoxidized soybean oil, and other epoxy-based plasticizers; plasticizers obtained from sebacic acid, adipic acid, azelaic acid, phthalic acid, and other dibasic acids and ethylene glycol, diethylene glycol, triethylene glycol, propylene glycol, dipropylene glycol, and other dihydric alcohols; molecular weight 500 or higher or 1000 or higher polyethylene glycol, polypropylene glycol, polytetramethylene glycol, and other polyether polyols, and polyether-based plasticizers as derivatives thereof. Of these plasticizers, it is advantageous to use phthalate esters, nonaromatic dibasic acid esters, and phosphate esters. The plasticizer preferably includes dibutyl phthalate, dioctyl phthalate, diisononyl phthalate, diisodecyl phthalate, octylbutyl phthalate, or other phthalate esters, and more preferably contains dioctyl phthalate. A plasticizer containing a phthalate ester, particularly dioctyl phthalate, can provide a sealing composition having particularly high tensile strength.

The plasticizer is contained in the sealing composition generally in an amount of about 10 parts by mass or higher, about 20 parts by mass or higher, or about 30 parts by mass or higher, to about 60 parts by mass or lower, about 55 parts by mass or lower, or about 50 parts by mass or lower, based on 100 parts by mass of the sealing composition.

In a certain embodiment, the mass ratio of the plasticizer to the polyvinyl chloride resin (mass of plasticizer/mass of polyvinyl chloride resin) is about 0.8 or higher, about 0.85 or higher, about 1 or higher, or about 1.5 or higher, to about 5 or lower, about 4 or lower, about 3 or lower, or about 2 or lower. Increasing the amount of plasticizer per the polyvinyl chloride resin allows more hollow glass microspheres to be contained in the sealing composition. In an embodiment in which the hollow glass microspheres are contained in the sealing composition in an amount of about 35 vol % or higher, the mass ratio of the plasticizer to the polyvinyl chloride resin can be set, for example, to about 0.85 or higher and about 5 or lower. In an embodiment in which the hollow glass microspheres are contained in the sealing composition in an amount of about 40 vol %, the mass ratio of the plasticizer to the polyvinyl chloride resin can be set, for example, to about 0.85 or higher or about 1 or higher to about 5 or lower. In an embodiment in which the hollow glass microspheres are contained in the sealing composition in an amount of about 50 vol % or higher, the mass ratio of the plasticizer to the polyvinyl chloride resin can be set, for example, to about 1.5 or higher and about 5 or lower.

The sealing composition may contain as optional ingredients untreated hollow glass microspheres, calcium carbonate, barium sulfate, clay, mica, and other fillers, solvents, isocyanate compounds, and other adhesiveness improving agents, titanium oxide, carbon black, and other colorants, antioxidants, ultraviolet absorbers, and other additives.

The sealing composition can be prepared by mixing the hollow glass microspheres surface treated with the above silane compound, with the polyvinyl chloride resin, plasticizer, and optional ingredients. Known equipment provided with agitating means and temperature regulating means as needed, for example, a planetary mixer, roll mill, or the like, can be used for mixing. The sealing composition may be defoamed by degassing during mixing or after mixing.

The viscosity of the sealing composition is, for example, about 4 Pa·s or higher or about 10 Pa·s or higher, to about 50 Pa·s or lower or about 40 Pa·s or lower when measured at a shear speed of 60 s⁻¹ after agitating and fully dispersing the composition and setting aside for about one day at room temperature. Sealing compositions having viscosities outside the above range also can be used in accordance with the purpose, place of application, and the like.

The sealing composition can be used for sealing gaps requiring sealing, by applying to the above gaps using a sealing gun or other application device, making the surface of the applied sealing composition uniform using a brush, spatula, or the like, and heat curing, for example, for about one to two hours at about 100 to 150° C.

The density of the cured product of the sealing composition is, for example, about 1.0 g/cm³ or lower, about 0.9 g/cm³ or lower, or about 0.8 g/cm³ or lower. The density of the sealing composition decreases as the amount of hollow glass microspheres increases, but generally is about 0.6 g/cm³ or higher or about 0.65 g/cm³ or higher.

The tensile strength of the cured product of the sealing composition is, for example, about 0.4 MPa or higher, about 0.8 MPa or higher, about 1.0 MPa or higher, or about 1.2 MPa or higher, to about 5 MPa or lower or about 3 MPa or lower.

The sealing composition of the present disclosure can be used ideally for sealing gaps between members constituting automobiles, ships, trains, and other vehicles. For example, the sealing composition of the present disclosure can be used for sealing seams of steel sheets constituting automobile doors, engine rooms, floor panels, hoods, and the like when painting these steel sheets.

### EXAMPLES

Specific embodiments of the present disclosure are illustrated in the examples below, but the present invention is not limited to these embodiments. Parts and percentages are all based on mass unless specifically stated otherwise.

The materials used in the present examples are listed in Table 1.

TABLE 1

| Product | | |
|---|---|---|
| name or | | |
| abbreviation | Description | Supplier |
| PSM-30 | Paste PVC (polyvinyl chloride) | Kaneka Corporation |
| | Viscosity of 3000 mPa · s | (Kita-ku, Osaka, |
| | | Japan) |
| PBM-6 | Paste PVC (polyvinyl chloride) | Kaneka Corporation |
| | Blend with vinyl acetate copolymer | |
| DOP | Plasticizer | Wako Pure Chemical |
| | Dioctyl phthalate | Industries, Ltd. |
| | (bis(2-ethylhexyl) phthalate) | (Chuo-ku, Osaka, |
| | | Japan) |
| DINP | Plasticizer | Wako Pure Chemical |
| | Diisononyl phthalate | Industries, Ltd. |
| DOA | Plasticizer | Wako Pure Chemical |
| | Dioctyl adipate | Industries, Ltd. |
| TTP | Plasticizer | Wako Pure Chemical |
| | Tritolyl phosphate | Industries, Ltd. |
| 3M ® glass | Hollow glass microspheres | 3M Japan Limited |
| bubbles | Average density 0.46 g/cm³ | (Shinagawa-ku, |
| iM16K | Volume median diameter 21.2 μm | Tokyo, Japan) |
| 3M ® glass | Hollow glass microspheres | 3M Japan Limited |
| bubbles | Average density of 0.38 g/cm³ | |
| VS5500 | Volume median diameter 38.3 μm | |
| Duranate ® | Block-type hexamethylene | Asahi Kasei Chemicals |
| TPA-B80E | diisocyanate | Corporation |
| | (HDI)-based polyisocyanate | (Chiyoda-ku, Tokyo, |
| | | Japan) |
| KBE903 | Aminosilane | Shin-Etsu Chemical |
| | 3-aminopropyltriethoxysilane | Co., Ltd. |
| | | (Chiyoda-ku, Tokyo, |
| | | Japan) |

### Evaluation Methods

The methods for evaluation of the sealing composition are as follows. Tensile strength of the cured product was measured using a Tensilon® Universal Testing Machine RTC-1325A (Load Cell 50N, UR-50N-D) (manufactured by Orientec Co., Ltd., Toyoshima-ku, Tokyo, Japan) using dumbbell test pieces as specimens. Two test pieces obtained from each of two sheets were used, and the average (n=4) of values measured when the test pieces were pulled at a temperature of 23° C. with a distance between clips of about 50 mm and a tension speed of about 50 mm/minute was taken as the tensile strength. Density was measured using an electronic densimeter SD-200L (manufactured by Alfa Mirage Co., Ltd., Miyakojima-ku, Osaka, Japan) using the dumbbell test pieces fabricated for tensile strength measurement as specimens. Viscosity was measured at a temperature of 25° C. and a shear speed of 60 s⁻¹ using a rotary viscometer HAAKE™ RheoStress™ 1 Rotational Rheometer (manufactured by Thermo Fisher Scientific, Inc., Kanagawa-ku, Yokohama, Japan).

### Preparation of Surface-Treated Hollow Glass Microspheres

Untreated hollow glass microspheres were thrown into a henschel mixer (New-Gra Machine SEG-750, manufactured by Seishin Enterprise Co., Ltd., Shibuya-ku, Tokyo, Japan) regulated to a temperature of 125° C. The hollow glass microspheres were agitated for about five minutes at a rotational speed of 160 rpm and then sprayed with KBE903. Next, the hollow glass microspheres were dried while agitating for 30 minutes at a rotational speed of 180 rpm and then removed from the mixer. The hollow glass microspheres were cooled to room temperature, and graded by sifting using an ASTM E11-04 No. 100 mesh (openings 150 micrometers) sieve and an ASTM E11-04 No. 40 mesh (openings 425 micrometers) sieve. The types of hollow glass microspheres and amounts used, as well as the amounts of KBE903 used, are listed in Table 2.

TABLE 2

| Sample name | iM16K- | iM16K- | iM16K- | iM16K- | VS5500- |
|---|---|---|---|---|---|
| | 0.25 | 0.4 | 0.8 | 1.0 | 1.0 |
| Hollow glass | iM16K- | iM16K- | iM16K- | iM16K- | VS5500- |
| microspheres | 45.0 | 45.4 | 45.6 | 45.1 | 45.2 |
| (parts) | | | | | |
| KBE903 | 0.11/ | 0.18/ | 0.37/ | 0.45/ | 0.452/ |
| (parts/mass %) | 0.25 | 0.4 | 0.8 | 1.0 | 1/0 |

1) Mass % of KBE903 is based on the mass of the hollow glass microspheres (mass of KBE903/mass of hollow glass microspheres)

### Preparation of Sealing Composition and Fabrication of Dumbbell Test Pieces

Polyvinyl chloride resin was mixed with hollow glass microspheres treated as noted above, DOP as a plasticizer, and TPA-B80E as an adhesiveness improving agent at the compositions listed in Table 3 for four minutes at a rotational speed of 1500 rpm using an “Awatori Rentaro” (manufactured by Thinky Corporation, Chiyoda-ku, Tokyo, Japan). The obtained mixture was depressurized to 0.007 MPa and defoamed for 10 minutes at 80 rpm in a vacuum agitator “Vacuum Degassing Mixter” (manufactured by Mixter Co., Ltd., Koto-ku, Tokyo, Japan), and a sealing composition was thus prepared.

The obtained sealing composition was poured into a square aluminum mold (140 mm×140 mm, depth 3 mm), and baked for one hour in an oven set at 140° C. The sheet of cured sealing composition was then punched using a JIS K6251-2 (2010 edition) dumbbell type 2 punching die, and a dumbbell test piece was thus fabricated.

Sealing compositions were prepared in the same manner using non-surface-treated hollow glass microspheres, and dumbbell test pieces were fabricated as comparative examples.

### Evaluation Results

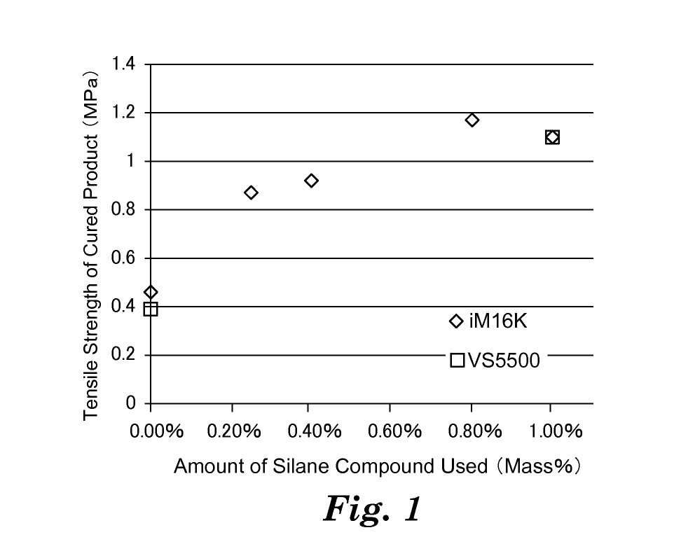

The results of evaluations of the cured products of the sealing compositions are listed in Table 3. FIG. 1 shows the relationship between the amount (mass %) of silane compound used and the tensile strength (MPa) of the cured material.

TABLE 3

| | Ex. 1 | Ex. 2 | Ex. 3 | Ex. 4 | Ex. 5 | Comp. Ex. 1 | Comp. Ex. 2 |
|---|---|---|---|---|---|---|---|
| PVC total | 20.9 | 20.9 | 20.9 | 20.9 | 22.0 | 20.9 | 22.0 |
| (PSM-30) | 16.7 | 16.7 | 16.7 | 16.7 | 17.6 | 16.7 | 17.6 |
| (PBM-6) | 4.2 | 4.2 | 4.2 | 4.2 | 4.4 | 4.2 | 4.4 |
| DOP | 41.7 | 41.7 | 41.7 | 41.7 | 44.1 | 41.7 | 44.1 |
| iM16K | | | | | | 35.4 | |
| (untreated) | | | | | | | |
| iM16K-0.25 | 35.4 | | | | | | |
| iM16K-0.4 | | 35.4 | | | | | |
| iM16K-0.8 | | | 35.4 | | | | |
| iM16K-1.0 | | | | 35.4 | | | |
| VS5500 | | | | | | | 31.7 |
| (untreated) | | | | | | | |
| VS5500-1.0 | | | | | 31.7 | | |
| TPA-B80E | 2.1 | 2.1 | 2.1 | 2.1 | 2.2 | 2.1 | 2.2 |
| Volume % of | 57 | 57 | 57 | 57 | 57 | 57 | 57 |
| hollow glass | | | | | | | |
| microspheres | | | | | | | |
| DOP/PVC | 2.0 | 2.0 | 2.0 | 2.0 | 2.0 | 2.0 | 2.0 |
| (mass ratio) | | | | | | | |
| Density (g/cm³) | 0.73 | 0.73 | 0.73 | 0.73 | 0.68 | 0.71 | 0.63 |
| Tensile strength | 0.87 | 0.92 | 1.17 | 1.1 | 1.1 | 0.46 | 0.39 |
| (MPa) | | | | | | | |

Polyvinyl chloride resin was mixed with iM16K-1.0 as surface-treated hollow glass microspheres, DOP as a plasticizer, and TPA-B80E as an adhesiveness improving agent at the compositions listed in Table 4 for four minutes at a rotational speed of 1500 rpm using an “Awatori Rentaro” (manufactured by Thinky Corporation, Chiyoda-ku, Tokyo, Japan). The obtained mixture was depressurized to 0.007 MPa and degassed for 10 minutes at 80 rpm in a vacuum agitator, and a sealing composition was thus prepared.

The viscosity of the sealing composition was measured, dumbbell test pieces were fabricated in the same manner, and the physical properties of the cured products were evaluated. The results are listed in Table 4. In Table 4, compositions of which the viscosity could not be measured are noted as “ND,” and those of which the tensile strength was not measured are noted as “-.”

TABLE 4

| | Ex. 6 | Ex. 7 | Ex. 8 | Ex. 9 | Ex. 10 | Ex. 11 | Ex. 12 | Ex. 13 | Ex. 14 | Ex. 15 |
|---|---|---|---|---|---|---|---|---|---|---|
| PVC total | 46.1 | 45.5 | 41.2 | 37.1 | 29.1 | 23.5 | 23.3 | 21.7 | 21.3 | 9.9 |
| (PSM-30) | 36.9 | 36.4 | 33.0 | 29.7 | 23.3 | 18.8 | 18.6 | 17.4 | 17.0 | 7.9 |
| (PBM-6) | 9.2 | 9.1 | 8.2 | 7.4 | 5.8 | 4.7 | 4.7 | 4.3 | 4.3 | 2.0 |
| DOP | 36.9 | 31.8 | 36.3 | 39.6 | 46.5 | 52.2 | 44.2 | 43.5 | 42.6 | 49.5 |
| iM16K-1.0 | 15.2 | 20.9 | 20.9 | 21.3 | 22.1 | 22.0 | 30.2 | 32.6 | 34.0 | 39.6 |
| TPA-B80E | 1.8 | 1.8 | 1.6 | 2.0 | 2.3 | 2.3 | 2.3 | 2.2 | 2.1 | 1.0 |
| Volume % of | 31 | 40 | 40 | 40 | 40 | 39 | 51 | 53 | 55 | 60 |
| hollow glass | | | | | | | | | | |
| microspheres | | | | | | | | | | |
| DOP/PVC | 0.80 | 0.70 | 0.88 | 1.1 | 1.6 | 2.2 | 1.9 | 2.0 | 2.0 | 5.0 |
| (mass ratio) | | | | | | | | | | |
| Density | 0.95 | 0.90 | 0.89 | 0.87 | 0.85 | 0.84 | 0.77 | 0.75 | 0.74 | 0.69 |
| (g/cm³) | | | | | | | | | | |
| Viscosity | 52 | 59 | 32 | 11 | 6 | 2 | 13 | 23 | 31 | 45 |
| (Pa · s, 60 s⁻¹) | | | | | | | | | | |
| Tensile | — | — | — | 1.92 | 1.21 | 0.79 | — | 1.08 | 1.31 | (0.43)¹⁾ |
| strength | | | | | | | | | | |
| (MPa) | | | | | | | | | | |

| | Comparative Example | Comparative Example | Comparative Example |
|---|---|---|---|
| | 3 | 4 | 5 |
| PVC total | 67.6 | 57.6 | 6.3 |
| (PSM-30) | 54.1 | 46.1 | 6.3 |
| (PBM-6) | 13.5 | 11.5 | 0.0 |
| DOP | 13.5 | 26.2 | 45.8 |
| iM16K-1.0 | 12.2 | 13.8 | 45.8 |
| TPA-B80E | 6.8 | 2.3 | 2.1 |
| Volume % of | 27 | 29 | 65 |
| hollow glass | | | |
| microspheres | | | |
| DOP/PVC | 0.20 | 0.46 | 7.3 |
| (mass ratio) | | | |
| Density (g/cm³) | 1.05 | 1.00 | 0.65 |
| Viscosity | ND | ND | ND |
| (Pa · s, 60 s⁻¹) | | | |
| Tensile | — | — | — |
| strength | | | |
| (MPa) | | | |

¹⁾Reference value (The cross-sectional shape was incorrect because the smoothness of the test piece surface was low, and sufficient measurement precision could not be obtained.)

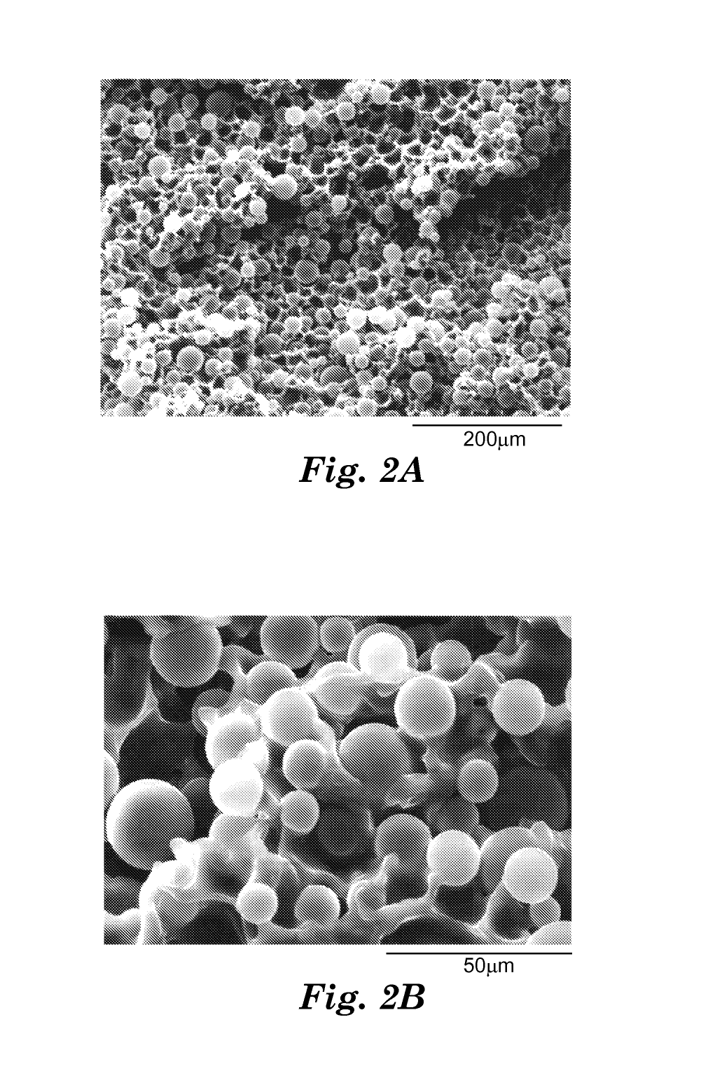

FIGS. 2A and 2B show SEM photographs (FIG. 2A: 200×, FIG. 2B: 1000×) of the tensile fracture surface of cured product of the sealing composition of Example 13.

Polyvinyl chloride resin was mixed with iM16K-1.0 (surface treated) or iM16K (untreated) as hollow glass microspheres, DINP, DOA, TTP, or DOP as a plasticizer, and TPA-B80E as an adhesiveness improving agent at the compositions listed in Table 5 for four minutes at a rotational speed of 1500 rpm using an “Awatori Rentaro” (manufactured by Thinky Corporation, Chiyoda-ku, Tokyo, Japan). The obtained mixture was depressurized to 0.007 MPa and degassed for 10 minutes at 80 rpm in a vacuum agitator, and a sealing composition was thus prepared.

The viscosity of the sealing composition was measured, dumbbell test pieces were fabricated in the same manner, and the physical properties of the cured material were evaluated. The results are listed in Table 5. In Table 5, compositions of which the viscosity could not be measured are noted as “ND.” The rate of improvement of tensile strength (%) is a value calculated by the formula below where T₀ is the tensile strength using non-surface-treated hollow glass microspheres and T_{S} is the tensile strength using surface-treated hollow glass microspheres.

Rate of improvement of tensile strength (%)=((T_{S}−T₀)/T₀)×100 Formula 1

TABLE 5

| | Comp. | | Comp. | | Comp. | | Comp. | |
|---|---|---|---|---|---|---|---|---|
| | Ex. 6 | Ex. 16 | Ex. 7 | Ex. 17 | Ex. 8 | Ex. 18 | Ex. 9 | Ex. 14 |
| PVC total | 21.4 | 21.4 | 21.8 | 21.8 | 19.8 | 19.8 | 21.3 | 21.3 |
| (PSM-30) | 17.1 | 17.1 | 17.5 | 17.5 | 15.8 | 15.8 | 17.0 | 17.0 |
| (PBM-6) | 4.3 | 4.3 | 4.3 | 4.3 | 4.0 | 4.0 | 4.3 | 4.3 |
| DINP | 42.3 | 42.3 | | | | | | |
| DOA | | | 41.0 | 41.0 | | | | |
| TTP | | | | | 46.8 | 46.8 | | |
| DOP | | | | | | | 42.6 | 42.6 |
| iM16K | 34.2 | | 35.0 | | 31.4 | | 34.0 | |
| (untreated) | | | | | | | | |
| iM16K-1.0 | | 34.2 | | 35.0 | | 31.4 | | 34.0 |
| TPA-B08E | 2.1 | 2.1 | 2.2 | 2.2 | 2.0 | 2.0 | 2.1 | 2.1 |
| Volume % of | 55 | 55 | 55 | 55 | 55 | 55 | 55 | 55 |
| hollow glass | | | | | | | | |
| microspheres | | | | | | | | |
| Plasticizer/PVC | 1.98 | 1.98 | 1.88 | 1.88 | 2.37 | 2.37 | 2.00 | 2.00 |
| (mass ratio) | | | | | | | | |
| Density (g/c^{m3}) | 0.74 | 0.74 | 0.72 | 0.73 | 0.81 | 0.81 | 0.75 | 0.74 |
| Viscosity | 18 | 20 | ND | 14 | 24 | 24 | 22 | 31 |
| (Pa · s, 60 s⁻¹) | | | | | | | | |
| Tensile | 0.45 | 1.18 | 0.28 | 1.15 | 0.68 | 0.89 | 0.48 | 1.31 |
| strength (MPa) | | | | | | | | |
| Rate of | — | 162 | — | 311 | — | 31 | — | 173 |
| improvement | | | | | | | | |
| of tensile | | | | | | | | |
| strength (%) | | | | | | | | |

1. A sealing composition comprising a polyvinyl chloride resin, hollow glass microspheres having a surface treatment, and a plasticizer, the sealing composition containing 30 to 60 vol % of the hollow glass microspheres.

2. The sealing composition according to claim 1, wherein a mass ratio of the plasticizer to the polyvinyl chloride resin is 0.8 to 5.

3. The sealing composition according to claim 1, wherein the surface treatment is a surface treatment with an aminosilane.

4. The sealing composition according to claim 1, wherein the sealing composition contains 40 to 60 vol % of the hollow glass microspheres.

5. The sealing composition according to claim 1, wherein the plasticizer is at least one selected from a group including phthalate esters, nonaromatic dibasic acid esters, and phosphate esters.

6. The sealing composition according to claim 5, wherein the plasticizer comprises a phthalate ester.

7. The sealing composition according to claim 6, wherein the plasticizer comprises dioctyl phthalate.

8. The sealing composition according to claim 1, wherein a viscosity at a shear speed of 60 s⁻¹ is 4 Pa·s to 50 Pa·s.

9. The sealing composition according to claim 1, wherein a tensile strength of a cured product is 0.4 MPa or higher.

10. The sealing composition according to claim 1, wherein the sealing composition is used in automotive paint.

11. A method of producing the sealing composition according to claim 1, the method comprising:
surface treating hollow glass microspheres with a silane compound surface treatment, and mixing the surface-treated hollow glass microspheres with a polyvinyl chloride resin and a plasticizer.

12. The method according to claim 11, wherein the silane compound contains an aminosilane.

13. The method according to claim 11, wherein the surface treatment is performed using 0.25 mass % or more of the silane compound per the hollow glass microspheres.
